(19) United States
(12) Patent Application Publication
(10) Pub. No.: US 2009/0271790 A1
(43) Pub. Date: Oct. 29, 2009

(54) COMPUTER ARCHITECTURE

(76) Inventor: Paul Williams, Derbyshire (GB)

Correspondence Address: Fay Sharpe LLP, 1228 Euclid Avenue, 5th Floor, The Halle Building, Cleveland, OH, 44115, US

(21) Appl. No.: 12/293,290

(22) PCT Filed: Mar. 19, 2007
(86) PCT No.: PCT/GB2007/000920

§ 371 Date: Mar. 12, 2009

(30) Foreign Application Priority Data
Mar. 17, 2006 (GB) 0605383.9

(51) Int. Cl. G06F 9/30; G06F 9/46

(52) U.S. Cl. 718/100; 712/208; 712/220; 712/E09.016

(57) ABSTRACT

A computer processor comprises a memory and logic and control circuitry utilizing instructions and operands used thereby. The logic and control circuitry includes: an execution buffer each location of which can contain an instruction or data together with a tag indicating the status of the information in the location; means for executing the instructions in the buffer in dependence on the statuses of the current instruction and the operands in the buffer used by that instruction, and a program counter for fetching instructions sequentially from the memory. The tags include data, instruction, reserved, and empty tags. The processor may to execute instructions as parallel tasks subject to their data dependencies and a system may include several such processors. FIGS. 2-5 show successive stages of the execution buffer in performing a short program.

The present invention provides a versatile and powerful way to process a computer program.

Within a standard or conventional computer system, a processor is used to execute a program. There are a wide variety of processing systems but the majority follow a similar architecture and structure. There are a number of features that generally characterize a standard system, including (but not limited to):
1. The processor implements a defined set of instructions, for example Add, Subtract, etc.
2. The program is written using these instructions organized as a sequential list of instructions to implement the required function.
3. A number of instructions are additionally implemented within the processor and using them within a program allows the program execution to make a conditional branch (i.e. continue execution of the program from a different location within the program). Thus if points within the program are labelled (in the human readable form of the program) then an instruction can be used to branch to a labelled point if a certain test condition is satisfied. Such conditional instructions are generally referred to as Branch Instructions.
4. Instructions may additionally be implemented within the processor to enable program execution to break the sequential order of execution and continue execution from a different location within the program. Such instructions are generally referred to as Jump Instructions. The processor will sequentially execute the program up to the Jump Instruction and will then modify the program counter to an address specified in or by the Jump Instruction and then continue sequential execution from that address.
5. A number of instructions are additionally implemented whereby the program (or parts thereof) can be separated into parts commonly referred to as subroutines or functions. Another part of the program can then execute an instruction to execute the said subroutine—these instructions being generally referred to as Subroutine Calls or Function Calls. When the processor encounters such an instruction it will sequentially execute the subroutine or function before returning to continue sequential execution of the program at the instruction following the Subroutine or Function Call.
6. The processor sequentially reads and executes the instructions from a program. Within this paradigm, when an instruction is read and decoded it is executed. Execution follows Branch, Jump, Subroutine Calls and Function Calls maintaining the sequential order and treating the execution of the program as a single process.

A conventional processor has a fairly simple structure the design of which has been established for several decades. The basic structure comprises a set of registers, an arithmetic unit, an instruction decoder, and a program counter register.

Memory is generally provided within the system either internal or external to the processor. A program is stored in the memory, and the instructions read into the processor's instruction decoder, where each instruction in turn is decoded and then performed by the processor. The program counter steps through the instructions sequentially. After each instruction is decoded and executed, the program counter is incremented to contain the address of the next instruction in the sequential program (except for Branch and Jump Instructions which modify the program counter).

Within the prior art processor for execution of sequentially structured programs, the processor instructions specify the location of the instruction's operands. For example, an Add instruction will specify the registers that will contain the operands. In addition the instruction will define the destination for the result.

For subroutine and function calls the operation is normally more complex. When the subroutine is started, the processor will first save some limited part of the processor's internal state on a system stack. When the subroutine or function ends, the processor will load the saved data back from the system stack to partially restore the state of the processor to its state before the subroutine or function call, and will then continue execution. However, in prior art processors this restoration of the state of the processor has various weaknesses and does not fully restore the state, as explained further herein. For example, only limited information is stored to the system stack when the subroutine or function call is executed. The subroutine or function (or any program executed as a result of an interrupt) can modify other parts of the system's state and these will not be restored when the subroutine or function ends. In addition, within prior art processors of this type the system stack can be used for a variety of purposes and accessed by software. There are several problems with this including: (1) data can be added to or removed from the stack such that the processor does not restore the correct information at the end of the subroutine or function call, or (2) software could modify the contents of the stack and could modify or replace the data that will be used to restore the system's state at the end of the subroutine or function call.

Within most standard systems there is also a hardware signal referred to as an Interrupt signal, which is used to indicate that some item of hardware within the system requires attention. The interrupt signal behaves in a similar manner to a subroutine call except that the address of the subroutine that is to be executed is a system defined value; usually fixed in the processor design.

The present invention provides a computer processor for processing a computer program or part thereof including a number of instructions, where the overall function of the program is dependent on the instructions therein and at least in part on their order or position within the program, the processor including means to read and decode instructions within the program, characterized by:

validity setting means for setting the validity of a data operand for an instruction, and
execution means for executing one or more instructions (tasks) in dependence of the validity of the instruction's operands,
and in that the execution means are capable of executing instructions prior to completing the execution of one or more preceding instructions in the sequential order of the program.

A fundamental aspect of the present system is that the sequence in which the instructions are performed does not have to be sequential. An instruction can be performed as soon as its operands are available. The sequencing of instructions is controlled by the operand tags; an instruction cannot be performed until all its operands have valid tags. This is in contrast to a conventional system, where the instruction sequence strictly follows the order defined within the program. The present system is inherently capable of parallelism, i.e. instructions executing independently; the operand tag system ensures that instructions do not execute out of proper sequence. The use of tagging at the instruction level extends naturally to the subroutine level.

A system embodying the present invention will now be described by way of example and with reference to the drawings, in which:

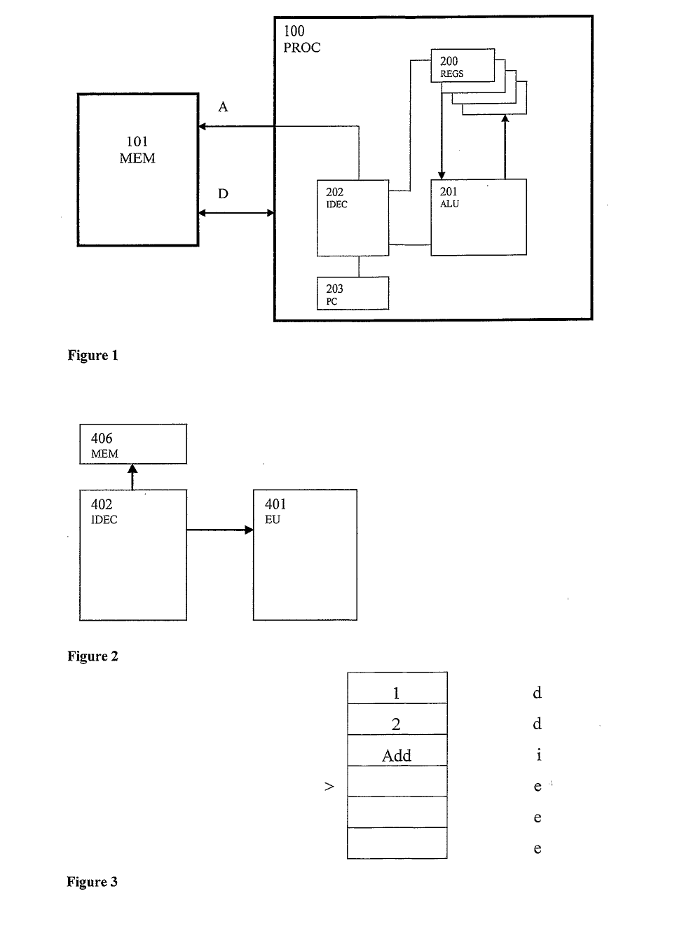

FIG. 1 is a simplified block diagram of a conventional system;

FIG. 2 is a highly simplified diagram of the part of the present system;

FIGS. 3 to 6 are diagrams of the execution buffer of the present system and its operation;

FIG. 7 shows the simplified structure for circuitry associated with the instruction flow during the basic execution mechanism; and

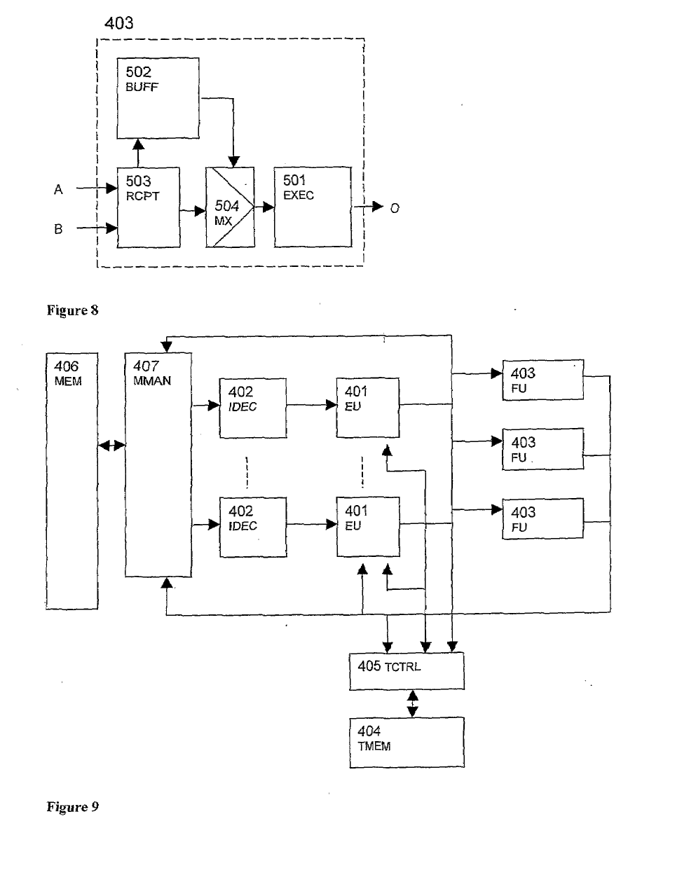

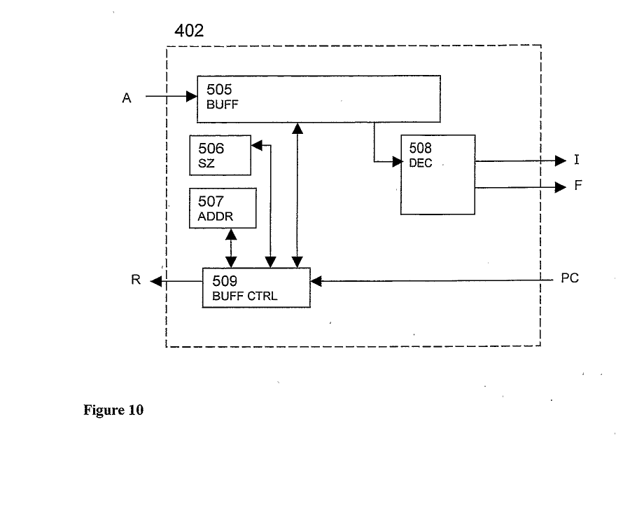

FIGS. 8 to 10 are more detailed diagrams of further parts of the present system including example implementations of a functional unit (FIG. 8), an overall system with multiple execution and functional units (FIG. 9) and an implementation of an instruction decoder unit (FIG. 10).

FIG. 1 shows a simplified structure for a standard system and processor 100. The system contains a memory 101 and the processor 100. Within the processor there are a plurality of registers 200, an arithmetic unit 201, an instruction decoder 202 and a program counter register 203.

A program is stored in memory 101 and the processor can read memory by issuing a Read instruction to 101 using the A connection. The read will specify the address in memory 101 that the processor wishes to read. Connection A will contain an address value and control signals sufficient to perform a read operation from the memory. The memory will output the content of the required memory location on connection D.

The program counter 203 is used to contain the memory address of the next instruction within the program to be executed. Within a standard system the memory may, for example, be 32 bits wide and thus each memory address will contain a 32 bit value. The program will be stored in the memory and the program counter initially sot to the start address of the program. The Instruction Decoder 202 will read program counter 203 and issue a read operation to the memory with the address defined by 203. The associated program instruction will be read from memory and decoded by instruction decoder 202 which will then control the internal operation of the processor to execute the instruction and increment the value of program counter 203 to be the address of the next program instruction. If an instruction is, for example, an Add that uses the data in two registers as operands, then instruction decoder 202 will control arithmetic unit 201 to perform the instruction and the circuitry to store the result back into the required register.

In some standard processors the operand locations for an instruction are implicit (for example an instruction may always use the current values in specific registers 200). In other processors the operand locations can be defined as part of the instruction (for example which registers 200 are used). Thus instruction decoder is 202 may select the appropriate registers, for example via a multiplexor, to provide the operands to arithmetic unit 201. The same form/value of an instruction will access operands from the same locations and have the same function.

Programs are structured as sequential lists of instructions so in general the value of the program counter will be incremented each time an instruction is fetched (so that it then references the next instruction). Branch instructions, Jump instructions, Subroutine Calls or Function Calls however require a different functionality and may result in a new value being loaded into program counter 203.

For a branch instruction, the new value stored in program counter 203 will either be the old value incremented (the branch was not taken) or a new value (the branch was taken). A Jump instruction will load a new value into program counter 203.

For subroutine and function calls the operation is normally more complex. In many standard designs the processor will save some part of the processor's internal state (such as the state of some registers and the program counter value) to memory (often a system stack within memory) before the subroutine or function's address is loaded to program counter 203 and sequential execution from that address commenced. When a subroutine or function ends, a special return instruction is executed. When the return instruction is executed, the processor will load data from the system stack to defined locations in the processor (such as the program counter 203) and will then continue execution.

Where a stack is used the standard processor contains a stack pointer register. This (directly or in combination with other values) defines the location in memory 101 to use to save or load processor state information. The following is an example of the standard operation:

If a subroutine call is decoded the processor may save data from four registers (of registers 200) and the program counter 203's value to the system stack. These will be sequentially written to memory 101 at the address specified by the stack pointer, and after each write the stack pointer's value is incremented. Thus the register values are written to sequential memory locations. When a RETURN instruction is executed (to end the subroutine and return execution to the original program location) the reverse process is performed, and data values read from the stack into the registers with the stack pointer being decremented prior to each read.

Generally any program has access to the system stack. In many processors a program will have access to all memory, which inherently includes the system stack. Also, in many processors instructions are specifically provided to add or remove data values from the system stack. For example, a PUSH instruction may write a data value onto the stack at the location defined by the stack pointer and then increment the stack pointer by one.

Within such a prior art processor, if a subroutine is executed (thereby adding prior status information to the stack) and the subroutine adds further information to the system stack but does not remove it and then a return instruction is executed, the processor will restore information from the system stack to its internal registers.

However, it will restore the wrong values because of the presence of the additional information which will be read as if it were part of the processor's internal state stored on execution of the subroutine. A similar problem exists if a subroutine removes information from the system stack.

Within most standard systems there is a hardware signal referred to as an Interrupt signal. This is a digital signal to the processor and is used to indicate that some item of hardware within the system requires attention. For example, it can be used to signal that the keyboard interface in a computer has a key character resulting from a user pressing a key on the keyboard. Within a system it may be preferable to generate interrupts from a number of hardware circuits (for example disk drive controller, keyboard controller, communication devices, etc.). However, prior art processors commonly have one (or a very limited number) of interrupt signals. Thus an interrupt controller can additionally be used within a prior art system and this generates a single interrupt to the processor which is a combination of a plurality of interrupt signals to the interrupt controller.

The processor's interrupt signal causes behaviour similar to a subroutine call except that the address of the subroutine that is to be executed is a hardware defined value. The system designer must locate a program at this defined memory address to deal with interrupts. When an interrupt signal occurs, the processor will save its present state (to the system stack in a similar way to when a subroutine call is executed) and it will then load the system defined address of the interrupt handling program into the program counter 203. The interrupt handler can then interrogate the system hardware (including interrupt controller if used) to determine the source and nature of the interrupt. This is often achieved by providing various registers within the hardware (for example a keyboard controller or communications port) and assigning a memory address to the registers such that when the processor reads (or writes) to the said address, the value of the register is returned (or set). To determine the source and nature of an interrupt, the prior art processor generally has to read a plurality of registers within the hardware system.

It is common within prior art systems for a single interrupt routine to handle the initial processing of multiple different sources of interrupt. This complicates and slows the system. It also limits the handling and management of interrupts. Additionally, it is common within many prior art processors for a means to be provided for interrupts to be disabled. This is commonly achieved using it status bit within the processor (and/or interrupt controller) that can be modified under program control. When an interrupt occurs the status bit is set to disable further interrupts. The interrupt program can then perform critical tasks before enabling further interrupts. However, it is a weakness of prior art systems that interrupts are disabled for a period.

When the interrupt handler has dealt with the cause of the interrupt it can issue a return instruction to resume the previous program execution. In some standard systems the processor saves additional data compared to that saved on a subroutine call. Therefore more stack locations are used. Also, the interrupt handler routine is terminated with an interrupt return (rather than a standard subroutine return) which ensures that the correct number of values are restored from the system stack. The correct operation is dependent on the programmer using the correct instructions (for example a return for a subroutine and an interrupt return for an interrupt routine) and the programmer, program or system not modifying the stack contents or adding or remove items to/from the stack such that a return results in incorrect state data being restored.

The interrupt system within many prior art processors can be characterized as:
1. There are a finite number of interrupt signals to the processor;
2. An interrupt will suspend the processor's current activity;
3. When an interrupt occurs one or more sources of interrupt are disabled; and
4. The processor has to perform some initial processing to determine the source and nature of the interrupt.

Within a prior art system the processor sequentially executes a program with the execution flow following the sequential order of the instructions and the subroutine and function calls. Thus the processor will execute the instructions sequentially from a program and at each subroutine call will sequentially execute that subroutine. In the prior art processor it is therefore as if the instructions from the subroutine had simply been inserted into the calling program to form one aggregated sequential list of instructions.

The present system processes tasks (where a task may be a single instruction or may be the execution of a program). The task will be executed by hardware appropriate to the individual task. Thus one task may be executed within an arithmetic unit whereas another task is executed by an Execution Unit. Within the present system an Execution Unit processes tasks that involve the processing of a program. Within the present system the Execution Unit is a specific form of functional unit, used to execute a task.

Each task will have a dynamic state. The nature, format, structure and content of this may not only vary from one task to another but may vary dynamically. For example, when a task is created it may originate from a fairly simple instruction, for example InstructionX (OperandA). However, during the life of the task the state may vary significantly.

Within the present system an Execution Unit is used to process a task which is executing a program (or part thereof). Such a task has a state that will reflect the execution status and such task states are referred to herein as Execution States. In the preferred embodiment an Execution State will include, but not necessarily be limited to, information contained in an execution buffer, one or more general registers, a program counter, and optionally a return pointer to the reservation(s) in the parent task. The execution unit 401 is designed to substantially contain and process an Execution State, and thus contains the relevant hardware to do so. When not contained in an Execution Unit 401, an Execution State may be stored in memory and will contain substantially the same information but the information may be in a different format or structure compared to when it is in the Execution Unit 401 and will be in memory rather than the circuitry in Execution Unit 401.

It is a significant feature of the present system that for some instructions the instruction alone does not determine either the functionality of the instruction or the functional unit that will execute it (for the avoidance of doubt the instruction alone does not imply the type of functional unit that will execute it). The functionality and the unit used to process an instruction may be, at least in part, also determined by the type of operands used with the instruction and it is a further significant feature of the present system that the instruction does not itself explicitly contain those operands.

Within the present system the processor executes tasks where each task is substantively handled as a parallel process. When a subroutine is executed this is achieved by processing the subroutine as a task and this may be done within the same processor unit (i.e. suspending the parent/calling task) or by a separate processing unit potentially with the parent task continuing execution.

Within the present system Execution Units manage the execution of a task. They replace and are functionally different to units 200, 202 and 203 of a prior art processor (that is the instruction decoder, program counter and registers) together with associated control circuitry. Under hardware control, an Execution Unit may switch execution from one task to another.

If a program (P) was written that calls a subroutine (S1), which in turn calls a subroutine (S2), a prior art processor will stop executing P and S1 whilst executing S2. Once S2 completes (and returns), S1 will resume and P remains stopped. Only when S1 has completed and returned can P continue. It may be possible that P and S1 have subsequent instructions after the call instructions to the S1 and S2 respectively that were not dependent on the execution of the S1 or S2 subroutines (that is additional instructions in a task can be processed independent of a subroutine called by that task). However, the prior-art processor would have stopped these program sequences as soon as a subroutine call was encountered and would not resume the execution until the corresponding subroutine had completed. This is also true with interrupts. Not only would an interrupt stop the processing of a program whilst the interrupt code is executed, the prior-art processor may also receive another interrupt during the execution of the first. The first interrupt will in turn be stopped whilst the second interrupt is serviced. The first interrupt cannot resume execution until the second one is completed. Then, only once the first interrupt is completed can the previously executing programs continue executing.

The present system is designed such that P may continue executing at the same time as S1 executes. It is also possible that P and S1 will both continue executing while S2 is executed. Fundamentally, S1 could return results to P before S2 has even completed or returned any results to S1. Further, it may even be possible, for example, that S1 completes and terminates before S2 completes.

Similarly, within the present system interrupts do not in themselves necessitate any other program, subroutine or interrupt code to stop executing. If any programs, subroutines or interrupts can continue to execute independently (i.e. there are enough resources to facilitate them all running simultaneously), then there is no need for any of them to be stopped to service the interrupt. Further, where the execution of tasks becomes resource limited (for example, where there are more tasks than Execution Units) the present system prioritizes tasks and tasks can be executed dependent on their priority rather than the sequential order in which they occurred.

The order in which subroutines are called in the prior art system and the order in which tasks are created in the present system may also be very different. For example, if after calling S1, P calls a subroutine S3 then in the prior art system this call will only occur after S2 and S1 have both completed and execution eventually returned to P. However, in the present system effectively the same program would result in task P creating a task for S1, and if executing of P continued it may then create a task for S3 before the S1 task has encountered the subroutine call to S2 and thus created task S2. Each time a task is created in the present system (assuming the said task needs to return results), a link is created between the child and parent irrespective of the order in which the child and any other task in the system are created. A child task is created independently of any other task, with the appropriate link being maintained. Thus task S2 will have a return pointer to task S1 even though other tasks (such as S3) may have been created but not terminated in the period between S1 being created and it creating S2. This ability of the hardware to automatically continue execution of one task while generating child tasks (for example subroutines) is a significant feature of the present system.

The conventional stack model used by prior-art processors does not support this functionality, as control (and data) is simply passed from the current to the previous (in the stack sequence terms) or the current to the next (when a new subroutine is called).

In the conventional system there is no recognition within the underlying architecture of data validity. If an instruction is decoded and issued for execution, it is assumed that its operands are valid. Thus, if, for example, an Add instruction adds the contents of two registers it is assumed that when the instruction is decoded the registers contain the required data. Also, if an integer add is performed it is assumed that the locations used for the operands contain integers. In prior art systems it is common for instructions to contain their operands (or specify the location of the operands) and the instructions are therefore self contained. In the present system an instruction could similarly contain its operands but in the preferred embodiment at least some instructions do not explicitly contain the operands but rather simply define how many operands are required. Those operands are then provided as a result of the execution of the program instructions prior to the instruction in question.

In the present system, the validity of values within the processor are tagged or otherwise identified. Further, in the preferred embodiment the traditional register based architecture is not used as the primary basis for instruction operands. Rather there is an execution buffer which can be implemented using a dedicated number of memory words within the processor (or using a number of register circuits configured as a buffer).

FIG. 2 shows a simplified structure for the present system. Program information is stored in memory 406, and read by instruction decoder 402 that provides decoded instructions to Execution Unit 401. Execution Unit 401 includes circuitry to detect the validity of instruction operands and will issue instructions for execution when the required operands are valid. In the preferred embodiment Execution Unit 401 contains an execution buffer to store decoded instructions prior to their execution.

In principle, the execution buffer can be of infinite (and/or variable) size; in practice it is finite and in the preferred embodiment is organized as a cyclic buffer.

Herein this buffer is generally described by reference to diagrams such as FIG. 3 which illustrates only 6 buffer locations. However, in the preferred embodiment more locations are provided, for example 16. It is a feature of the present system that different implementations of the system can have different buffer sizes but each can be implemented such that they can execute the same software programs, provided that the minimum or smallest buffer size is known.

Within each Execution Unit a separate register is used as a program counter. This program counter in simple form is similar to a conventional program counter but specific enhancements are described thereto herein which form part of the present system. The data or instruction contained at the memory address referenced by the program counter is fetched, decoded and pushed into the buffer. The normal operation would then increment the program counter and repeat this process. If, for example, the program contained #1, #2, Add (where # is used to denote a data value rather than instruction), then after these 3 program steps were decoded the buffer's state would be as shown in FIG. 3.

In the diagram, the column to the right of the buffer indicates a tag for each word of the buffer. This tag can be implemented using additional memory or register bits (with the buffer word length being extended accordingly). In the above example “d” is used to represent data, “i” an instruction and “e” an empty location.

A convenient binary encoding for these values can be defined for an implementation and may be implementation specific. For example, the tag could be encoded using 3 bits with “e” (empty) being encoded as 000.

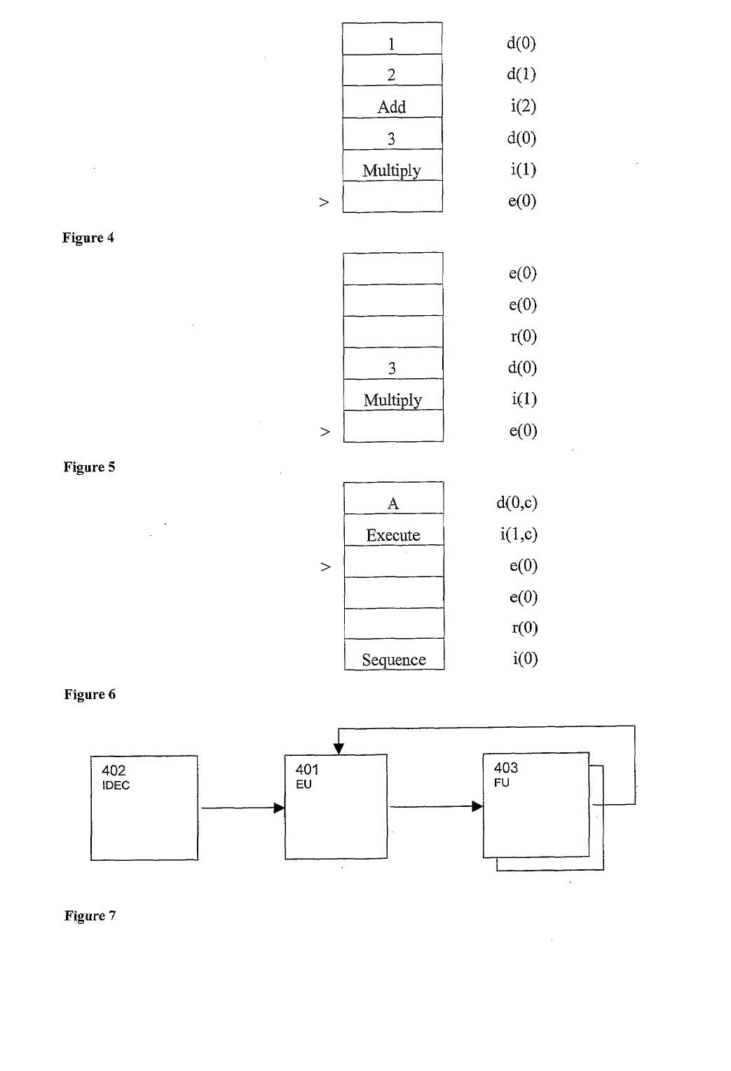

A significant feature of the present system is that circuitry associated with the buffer can detect when an instruction is present in the buffer with a complete valid set of data values. However, the further fetching of program information (data and instructions) is not dependent upon the prior execution of existing instructions in the buffer. Thus if #3 and Multiply were the next program instructions they could be fetched and pushed onto the buffer, giving a buffer state as shown in FIG. 4.

The multiply instruction requires two operands and therefore cannot execute, because only one operand has a data value. However, in this state the Add can execute.

In a prior art processor it is common for instructions to contain their operands (or the location of the operands). For example, ADD CX 10 would provide the instruction, the location of one operand and the value of the other operand. In the prior art processor an instruction is executed whenever it is reached and decoded in the sequential order of the program. In FIG. 3 the Add instruction does not, itself, contain its operands and will only execute when the operands are valid. If, in the example shown in FIG. 3, one of the operands never appeared in the execution buffer, then the Add would never execute. Thus the present system can detect programming errors which are undetectable in prior art systems. In particular the present system can detect a situation wherein an instruction exists in the execution buffer with no possibility of executing because there are insufficient data values below the instruction and nothing below the instruction that will generate data values.

Within the present system the encoding of instructions (and data) may vary depending upon its location within the system. Thus in memory instructions may be encoded one way and within the processor another. The present system is not dependent on the specific encoding or formatting but can be further enhanced and improved by means of the encoding.

Further, in the preferred embodiment the values used to represent instructions in the buffer are implemented such that circuitry associated with the buffer can easily determine the number of operands required by an instruction and the number of results that will be returned by the instruction. If, for example, these two parameters were both limited to the set of values 0, 1, 2, or 3, then 2 bits can be used to encode each parameter. Thus, where a buffer location contains an instruction, 4 bits of that location can be used to encode these two parameters. Within the processor, an implementation may use an entire execution buffer location to store a decoded instruction. Thus if the buffer location was 32 bits in size (excluding additional bits for tag and control information), 28 bits could be used to encode the instruction and 4 bits used for the said two parameters. In a further embodiment 4 bits could be used for the said two parameters but the whole 32 bits used to identify the instruction. This would mean that an instruction would have to be encoded with the correct value in the bits used for these two properties, would have a unique value (compared to other instructions with the same number of operands and results) in the other bits of the encoding, but could have the same value in these other encoding bits as an instruction with a different number of operands and/or results. The precise encoding is an implementation decision.

Within the program when stored in memory, the instructions may be encoded in a more compressed form (than is used within the processor). In the preferred embodiment, 4 bits are used to encode common instructions and the encoding is extendable to allow for more instructions. 4 bits can be used to represent sixteen values. In the preferred embodiment, most of these (say 12 values) are used for specific instruction (for example the most common 12 instructions). One or more further values may then be used to indicate that the following program information should be decoded as an immediate data value. For example, one 4 bit value could indicate that the next byte should be decoded as an immediate byte data value and another 4 bits value could indicate that the next 32 bits should be decoded as an immediate 32 bit integer value. This would then have used 14 of the 16 possible values (12 for common instructions and 2 to enable immediate data values to be loaded). Further, at least one value is used to indicate that an instruction is encoded with an extended format. Thus, for example, the next byte may contain an 8 bit instruction value, thereby giving a further 256 instructions. If desired, one value of the initial 4 bit encoding can be used to indicate an extended instruction and the next byte will then be decoded; however, 7 bits of this byte value will provide 128 instruction values but one bit of the byte will be used to indicate that the encoding is further extended in which case a further byte can be read—7 bits of which will give further bits of the instruction code and one bit will again indicate further extension of the encoding. Thus using this implementation an infinite size and number of instructions can be implemented.

Circuitry associated with the buffer determines the number of operands available prior to any buffer location. This value is shown in FIG. 4 by the value in brackets after the validity tag, for example 0 for the first location and 1 for the second location. This information can be used within the Execution Unit to control the execution of instructions. If a buffer location contains an instruction which defines the number of operands required for the instruction, and the number of data values (potential operands) available to that buffer location is at least equal to the number of operands required, then the instruction can be executed irrespective of its location within the buffer or its sequential order in the program.

In diagrams of the execution buffer herein the current top of the buffer is denoted by a “>” to the left of the associated buffer location. The value of “number of operands available” is determined using the following set of rules:
1. If the location is the bottom of the buffer (note that if the buffer is implemented as a cyclic buffer this may be the same location as the top of the buffer) then the value equals 0 otherwise:
   a. If the previous location contains data then the value equals the previous buffer location's “operands available” value plus 1;
   b. If the previous location contains an instruction or reservation (see later for explanation of reservation) then the value equals 0;
   c. If the previous location is empty then the value equals the previous location's “operands available” value.

Note that in this description (and elsewhere herein) the buffer is considered to be a cyclic buffer, so the location previous to location 1 is the last location in the physical buffer and location after the “last location” is location 1. The buffer can, however, be implemented in different forms including a stack like buffer with the oldest entry at the bottom and the most recent entry at the top. In such an implementation the contents of the buffer (other than reservations as described herein) can be shifted downwards as and when locations become empty such that the overall functionality is equivalent to that described herein.

New information should not be pushed from the instruction decoder into the buffer (at the top of buffer location) until the top of buffer location is empty. When information is pushed into the buffer, then the pointer to the top of the buffer will be modified (incremented) accordingly. Note that aspects of the buffer operation are implementation details so, for example, the top of buffer can either be incremented or decremented as data is added to the buffer, depending on whether the buffer fills/cycles upwards or downwards. For the purpose of this description the buffer is described as filling upwards with the most recent additions to the buffer being the highest and the oldest data in the buffer being in the lowest locations.

The top of the buffer is the location where information (when available) will next be added to the buffer.

An instruction that is ready to be issued with its operands from the Execution Buffer for execution will have a space in the execution buffer, where in the preferred embodiment this space consists of a consecutive set of buffer locations. In the preferred embodiment there may be empty buffer locations immediately above the instruction and/or the instruction may be the highest non-empty item in the Execution Buffer. The instruction's space can be defined as the continuous set of buffer locations that include the instruction and any operands together with any intervening empty buffer locations and any empty buffer locations either side of the instruction and its operands. The space will be such that the top of the space is bounded by the buffer location immediately lower than either the top of the buffer or the first non-empty location above the instruction. The bottom of the space will be defined by either the bottom of the buffer (if the bottom of the buffer is empty and all locations between it and the instruction's last operand are empty) or the location above the first non-empty location below the instruction/operands. The space also includes any empty locations between the instruction and its last operand.

When an instruction is issued for execution, any results of the instruction should be returned to the Execution Buffer to locations within the original instruction's space on the buffer. Thus the results of the instruction will be placed in the same sequential order of items in the buffer as the instruction and its operands had.

It is an implementation decision where in the instruction's space to return results to but options include:
1. A continuous set of locations starting from the location previously occupied by the original instruction and going down the buffer;
2. The highest locations in the original instruction's space in the buffer; note this would be the preferred embodiment if a cyclic buffer was implemented where items could be moved up the buffer to compress the buffer as described herein; and
3. The lowest locations in the original instruction's space in the buffer; note this would be the preferred embodiment if a stack like buffer was implemented where items could be moved down the buffer to compress the buffer as described herein. In addition results could be returned to the lowest locations in the space if the buffer is implemented as a cyclic buffer and the original instruction was the highest non-empty item in the buffer.

If an instruction returns more than one result it is preferred but not essential that the results are returned to consecutive locations in the execution buffer.

When an instruction is issued with its operands from the execution buffer (removed from the buffer and sent for execution), the return location can be implicitly controlled by circuitry whereby the instruction is executed and one or more results returned and such that the control circuitry can store the results in the Execution Buffer without risk of other circuitry placing other information in the required locations during the interim. If an instruction is executed quickly and local to the buffer then this could be achieved by control circuitry. However, it is proposed that most instructions are executed by functional units (such as arithmetic units) that are more loosely connected to the buffer circuitry.

There are a number of means whereby a particular implementation may be optimized but herein the present system is described by means of a tag value associated with each buffer location that indicates the state of the said location and can, amongst other values, indicate that the location is reserved. Thus when an instruction is issued from the execution buffer, the buffer's control circuitry can mark a sufficient number of locations in the buffer as reserved to accommodate the result(s) of the instruction once it has executed.

Control circuitry connected to the buffer can manage the issuing of instructions and emptying or reserving of the corresponding buffer locations. It is further proposed that an instruction and its operands can be issued for execution even if they do not exist in consecutive locations in the buffer and are separated by one or more empty locations.

A further significant feature of the present system is that instructions are considered as separate processes, i.e. tasks. They are issued for execution when their operands are valid and will return the relevant number of results. However, multiple instructions can be issued and executing at any time. In the FIGS. 3 and 4 example, the Add can be issued for execution and will return a single result. Thus the Add(1, 2) can be removed from the buffer, vacating three buffer locations, and a single location reserved for the result. The Add(1, 2) will be issued in such a way to enable the result to be returned to the now reserved buffer location. However, the present system can be further enhanced such that no reservation is required if the instruction can be executed such that it will automatically return the result to the correct location without that location being allocated or used during the interim. Thus, for example, if circuitry local to the buffer could execute the instruction and return a result within the same clock cycle, then the result can be loaded into the location previously occupied by, say, the instruction at the end of the particular clock cycle. The preferred embodiment incorporates both methods to return a result: namely (1) some instruction types may be executed quickly within or local to the buffer (within the Execution Unit) and will not use a reservation but will replace the instruction and any operands with the results and (2) some instructions will be issued and removed from the buffer with a reservation(s) being placed in the buffer for the results of the instruction to be returned to.

Assuming a reservation system, the buffer's state will be as shown in FIG. 5 after the “Add” is issued for execution. Note that one of the locations previously occupied by the Add(1, 2) instruction and operand set is now tagged as reserved (r) and the other previously used locations are empty.

In the preferred embodiment the tag information associated with data values is extended further such that, at least in some instances, the type of data can also be determined. This is a significant feature of the preferred embodiment and can be implemented in a number of ways including:
1. The range of values that can be represented by the tag field associated with each buffer location can be extended to identify the type of data (for example integer, byte, character, Boolean, etc.); and/or
2. The tag and buffer location in combination can be used to provide such information. For example, a particular value in the tag field can identify a group of data types and part of the buffer location then used to define the individual type. For example, a single value in the tag field can be used to identify a group of data types including bit, byte, 16 bit integer and character data types and a portion of the buffer location can then be used to identify which specific data type the buffer location contains.

In the preferred embodiment of the present system, an instruction may exist that will return the contents of the tag associated with a data value. The returned tag information may be identical to the location tags or may only consist of specific parts of the tag information, or may have a specific range of values. The values returned may also have a different format than those stored in the tag itself. Such an instruction is referred to herein as a Type instruction. The instruction may take a single operand and may either return two results, or a single result. Both forms will return a value representing the associated type of data for the supplied operand. If a version of the instruction returns two results, the second result may be a copy of the original operand unchanged. The Type instruction may be executed by control logic local to the execution buffer, where it may be more conveniently placed to access the associated tag information.

It is possible that empty locations may appear within the buffer between the oldest item in the buffer and the present top of buffer location. Preferably the buffer contents can be moved to compress the contents, thereby potentially creating free space at the top of the buffer for new items to be added. An implementation may have a trade-off between this feature and circuit complexity. One implementation could therefore be to embody this compression of the buffer but to do so without significant circuitry. For such an implementation, the contents of each buffer location can be moved one location in the buffer on each clock cycle. The following defines a general set of rules for whether the contents of a buffer location can be moved to another (new) buffer location:
1. The new location is empty and is not the present top of buffer location, and
2. The present location does not contain a reservation and is not empty, and
3. The move does not change the order of non-empty items in the Execution Buffer; that is it does not move something past/over a non-empty location.

Compression may be implemented in a number of ways and for the avoidance of doubt an implementation may move the contents of one or more buffer locations by more than one location in each move operation or step. However, the order of non-empty items stored in the buffer should not be changed.

If power consumption is a particular factor in an implementation, compression can be controlled by the ability to push items into the buffer. Thus, compression can be performed only when an item is available to push into the buffer and the present top of buffer location is not empty; that is the lack of compression is preventing something being added to the buffer. The compression can also be designed to endeavour to keep the present top of buffer location(s) empty but otherwise not operate.

The compression may also be implemented with the intention that the bottommost item in the execution buffer is always in the same physical buffer location (the bottom of the buffer). Since the compression does not move reservations, this may not be possible all of the time but the compression would be implemented to move the execution buffer contents down in the physical buffer (rather than up). Such an implementation could be used where the execution buffer is implemented as a form of stack rather than as a cyclic buffer.

The preferred embodiment can be further enhanced by enabling compression in both directions so that higher buffer locations are moved downwards towards the highest reserved buffer location and locations at the bottom of the buffer are moved upwards towards the lowest reservation.

Further, when issuing an instruction the reservation can be made at a currently empty location further up the buffer to the instruction being issued. Thus if a continuous set of one or more empty locations exist in the buffer immediately above the present instruction and below the top of buffer location, then the reservation can be made in any of these locations, preferably the highest in the buffer, without affecting the order of the buffer contents. Note that if the buffer is implemented as a stack like buffer rather than a cyclic buffer, it may be desirable to make reservations in the execution buffer at the lowest possible location (as opposed to the highest location, which is desirable in a cyclic buffer implementation).

Within the present system, each instruction can be considered as a parallel task (or process) and each can be issued when the corresponding operands are valid. The system, as described herein, contains various means to ensure the correct execution of programs, including controlling the execution sequence of some instructions. One means by which this is achieved is by using explicit sequencing instructions. One or more instructions (Sequence instructions) can be implemented within a system such that they affect the execution or issuing for execution of another instruction. For example, an Execute instruction can be used to execute a subroutine and the issuing of this instruction will be dependent upon the validity of that instruction's operands. However, the issuing can also be controlled by a prior Sequence instruction.

FIG. 6 shows an example. (This is deliberately constructed to show the buffer wrapping as a cyclic buffer.) Therefore there is a reservation (location 5), followed by a Sequence instruction which cannot execute because it requires one operand that is not yet present (which will come from the reserved buffer location 5). Above the sequence instruction is a data value “A” (which for the purpose of the example could be a memory address of a subroutine) at buffer location 1 and an Execute instruction at buffer location 2. The Execute in this example requires a single operand and should therefore be able to execute because it already has one valid operand. However, the Sequence instruction places a “c” flag on subsequent buffer locations (up to and including the next location to contain an instruction). This flag will prevent execution of an instruction in the associated location even if that instruction could otherwise execute.

Note that in the preferred embodiment a number of different forms of Execute instruction may be implemented each with a different number of operands and/or results. For example, if the Execute instruction is encoded in memory with the encoding format described herein, it may use a format where the first nibble is extended by a further 8 bit opcode value (thus encoded in 12 bits in total) and 16 discrete opcode values used for Execute to allow and permitted number and combination of operands and results (although this would provide one form of Execute with no operands and no results which could be unnecessary or could be used as a padding or null instruction if such was required). Such an encoding would be reasonably easily decoded by the instruction decoder to generate the required instruction format for use in the Execution Buffer.

At least one form of sequence instruction can be an instruction having a single operand and generating a single result which is identical to its operand (i.e. has no effect on the operand). The validity of this instruction's operand will (other factors aside) allow the instruction to execute, thereby removing the sequence instruction from the buffer and thereby removing the “c” flag from the next instruction in the buffer. This can be implemented to optimize such a sequence instruction by avoiding the need to store the sequence instruction in a separate buffer location and can, for example, use a special flag on the reserved location to indicate that that location also has a sequence instruction attached to it. Such a flag could be implemented either as an extra tag field on the buffer location or by means of using storage bits within the reserved buffer location to indicate this (for example a defined bit within the buffer word can be used in reservations to indicate a sequence condition). Alternatively the encoding of the subsequent instruction can be modified or a flag attached to indicate that issuing that instruction requires the “operands available” field to be at least 1 greater than the number of operands required by the instruction itself. An instruction can be modified, for example, by using one bit of the buffer word to indicate the presence of a sequence control on the instruction much like some bits of the buffer word may be used to indicate the number of operands and number of results for the instruction.

Within an embodiment of the present system, the Sequence instruction could be implemented to have zero operands and zero results but will only execute when the number of operands available to it is greater than zero. The effect of this would be the same as described above but the encoding of the instruction within the implementation would differ.

When an instruction is issued for execution, it is dealt with as an independent process (task), albeit with one or more potential connections to other tasks including possibly the parent task; it will have an identity within the system. However, it is not essential in many instances for this identity to have a formal task identifier (as described herein). Thus a simple instruction, for example an integer addition, may execute an instruction without that instruction having a formal identifier of its own.

It is intended that systems can be constructed with a plurality of processors embodying the present system. It is further proposed that where a significant number of processors exist within a system they can be organized in groups (namely clusters) with each group being connected to one or more other groups. Each cluster will contain one or more processors.

It is a significant feature of the present system that a number of processors can be connected together as a group and the hardware can, without software control, share the execution of multiple tasks between the available processors (and Execution Unit 401 therein). Further, that a task can be saved to memory (for example memory 404) by one Execution Unit 401 and subsequently loaded by another Execution Unit 401 which will then continue processing of the task. It is a significant feature of the present system that the results from sub-tasks (child tasks) will be correctly returned to a task irrespective of the current location or status of the said task.

Instructions when issued for execution are considered as tasks or processes. As stated some can be quickly and easily executed without reference to other data within the system. However, some tasks are more complex. Such tasks are preferably given an identity by means of assigning a task identifier. In general it is necessary for a task to have an identifier if it generates sub tasks, but any task may have an identifier and in the preferred embodiment all tasks that involve execution of a program are assigned an identifier.

The format and structure of the identifier may be a system design issue and/or may vary from location to location within a system. Thus, for example, if a child task is created which is expected to return results to the parent (more specifically, a reserved location within the parent), then the child will have a pointer or identifier for the parent and the location within the parent where the result(s) should be stored. If the child only exists within the same silicon chip (for example, processor) as the parent (and the parent is not suspended to memory), then the child's reference to the parent could, for example, be specific to the chip (i.e. a local task identifier or an identifier for the unit within the chip that has the parent task). If the parent and child may exist within different parts of the same cluster, then the identifier may have a different format, and where parent and child may be anywhere in the system they can have yet another format of reference or pointer. Thus, this description refers to identifiers and pointers but it is expressly recognized that within the present system the format and structure of them may vary, including dynamic variances.

It is expressly recognized that the naming of instructions and the construction of a processor's instruction set is part of an implementation and thus two implementations may incorporate the same instruction functionally but call it by different names—for example Add or Plus. In the description of prior art systems herein return is used to refer to instructions that terminate the execution of a subroutine or function and return program execution to the instruction following the subroutine/function call in the calling program. However, in the description of the present system, Return is used to refer to an instruction that passes a result from a child task (for example a subroutine or function) to the parent task but which may or may not terminate the child task. In the preferred embodiment a further instruction (End) is used to terminate a task.

The preferred embodiment of the present system enables a task (for example a subroutine) to return multiple results and a corresponding number of reservations will be created in the parent task's execution buffer. The child task may contain a counter indicating how many results the child is expected to return. In a further enhancement of the preferred embodiment the system can create an error or exception if a task tries to end when this return counter (the number of outstanding results from the task) is not zero. The system may also generate an error or exception when the task endeavors to return a result when the counter is already zero. It is proposed that whenever a Return instruction is executed (to return a result to the parent), the result counter is decremented. A Return instruction may also modify the return pointer to reference the next reservation or each result may be returned with a return pointer (to the correct reservation in the parent task) which is a function of the child's return pointer and the return counter (for example the return pointer plus or minus the return counter). In a further form of the preferred embodiment the “number of return results” property of a task is replaced by a set of flags with a flag for each potential result that the task may generate. Thus, for example, if a task can return a maximum of three results then three flags can be used and each flag could be a binary value. When the task is created the flags will be set according to the number of results expected. Thus if an Execute instruction is issued that has 3 results (and thus 3 reservations are made on the parent task's execution buffer) then all 3 flags can be set. As a child executes Return instructions, so call the flags be cleared indicating that the corresponding result has been generated. It is further proposed that an alternative form of Return instruction can be implemented that also specifies which result is being generated (the first, second or third) and such an instruction thereby explicitly defines which result flag to clear. This enables a task to actually generate the results in any order but ensure that they are correctly directed to the appropriate reservation in the parent task. The return pointer for each result will be a combination of the child task's return pointer and the flag that is being cleared (i.e. which return result is being generated—for example the first, second, or third). Thus, the return pointer for the second results may be the child task's return pointer plus or minus 1 and the return pointer for the third result may be the child task's return pointer plus or minus 2. An error or exception can be generated if a return instruction is executed (or issued/ready for execution) where the corresponding return flag is already clear.

When a result is generated by a task (or any instruction) the circuitry processing the task can create a message that is communicated within the system and that specifies the data (the result) being sent and a pointer (the results return pointer) which defines where the data is to be stored. The message can also contain a tag for the data to identify what type of data it is and optionally a tag for the pointer.

The preferred embodiment is designed such that the return pointer generated for a task's first result is returned to the highest reservation in the parent. The return pointer for a task's second result will reference the next reservation (that is the reservation immediately below the first) and so on. This is done because when the highest reservation is satisfied (and replaced with data), it may complete the operand set of an instruction in that Execution Buffer and that instruction will then be free to execute. If the lowest result was returned first its use would be blocked by any higher reservations.

When an instruction is issued that cannot be executed by nearby circuitry, there are a number of options within the present system. Such instructions may include but are not limited to subroutine or function calls, instructions to begin the execution of new programs, instructions with memory based operands, and instructions whose functionality is implemented in distant circuitry (that is circuitry where the instruction and operands have to be communicated some distance, perhaps to another chip, and where the instruction may therefore take several clock cycles to process and where it may not be desirable from an implementation perspective for the distant circuitry to be able to connect to all of the signals from the instruction's source). In the preferred embodiment all such instructions will be considered as parallel tasks to the original task. As such each will have its own Execution State which can be saved and loaded and which can be allocated to hardware resources for execution. The system may operate as follows:
1. It may save the original process and begin execution of the child process within the same circuitry;
2. The new process may be accepted by an Execution Unit that is presently idle or where it is determined that it is preferable for the Execution Unit to execute the new process rather than the process that it is currently executing. Examples of the latter may be when the new process has higher priority or when the existing process is stalled or at risk of stalling;
3. The new process (task) is communicated to circuitry that will take it to another location (which either has specific support for the instruction, is better placed for the operands or is deemed to be a better location for the tasks execution based on the workload and resource utilization within the system) and it will maintain a long reference or identifier as required for the return results; and
4. The new process may be saved either to local task caches or to a task pool.

In addition to the Execution Buffer, the Execution State for a task may also contain one or more registers. Each of these registers also has tag information associated with it, although the values and range of values may differ from the tag information for the Execution Buffer locations.

Execution States include information as described above, and each item of information within the Execution State may have a defined index or address within the Execution State. Thus, for example, if the execution buffer was 16 words in size then addresses 0 to 15 within the Execution State could contain the associated execution buffer contents. Similarly the tag information can be given an address within the Execution State. It is then possible to define instructions that can access a location within the Execution State. There are a variety of ways and forms in which such instructions could be implemented.

For example, two generic forms of instruction are Read(t, i) and Write(t, i, x) where “t” is a task identifier, “i” is an index or address within the task's Execution State and “x” is a data value. The read will return a data value from the specified location and Write will store “x” in the specified location. Return is a form of the Write instruction where the return pointer is the combination of “t” and “i” and “x” is the result being returned.

In the preferred embodiment, specific instructions are provided to enable data to be moved between a task's execution buffer and its registers. These are specific forms of the said Read and Write instructions whereby “t” is implied and is the current task.

In an implementation a Save(i, x) instruction may be implemented with two operands: namely an address or index for the register and a data value that should be stored in the register. A Load(i) may also be implemented with a single operand which is a register address within the Execution State and a single result which is the contents of that register.

An implementation may further optimize these instructions to provide an alternative form of them and this alternative form may optionally only exist in the execution buffer. Thus alternative form may embed the index (“i”) within the instruction such that it only requires a single execution buffer location. Thus if an integer was pushed onto the execution buffer followed by a Load instruction they could be combined to a LOADI instruction that contains the index or address within the encoding of the instruction and thereby only requires a single buffer location. Such an instruction would require no further operands. Similarly a Save with an index could be combined to a SAVEI form of the instruction with the index encoded in the instruction (thereby occupying a single execution buffer location) and this SAVEI would have one operand which is the data to save to the specified register.

Load(i) and LoadI should ultimately lead to a result (the register contents) being returned to the execution buffer and the register will become empty (the tag field is set to indicate an empty state). It is an implementation decision whether Load(i) can be directly executed to achieve this or whether Load(i) is sometimes or always converted into the LoadI form which then results in the said functionality.

A Copy(i) and CopyI can also be implemented whereby a copy of the contents of the specified register is returned to the execution buffer but the register is not emptied (that is its contents remains unchanged).

In the preferred embodiment of the present invention the system defines the functionality required if the system endeavors to write information into a non-empty location. For example, if the system endeavored to write data onto an Execution State location already containing an instruction. In the system at least two actions can be taken if this occurs:
1. An error is generated; or
2. the system executes the instruction with the data as an operand.

Conceptually the reservation previously described can be considered to be a special instruction whereby it executes only when data is written onto it (rather than an operand being available below it in the execution buffer), and its function is to simply replace itself with the data. Two further forms of reservation can be implemented, namely:
1. a forwarding reservation where the reservation contains a pointer (“P”). If a forwarding reservation is contained in location “L” then a write(L, x) will verify the contents of L and upon detecting a forwarding reservation in L will issue a write(P, x) instruction and empty location L (i.e. set its tag to an empty state). P may be a pointer (index) within the current task's Execution State or more generally could be any pointer.
2. a copy and forward reservation which has similar function as a forwarding reservation but which additionally puts a copy of “x” (the data in the original write instruction) into the location previously occupied by the copy and forward reservation and sets that location's tag accordingly (to be the tag value for the said data).

The operation of save, copy and load instructions within the system are controlled to ensure the correct operation; that is the operation that would result if the instructions were executed in the strict sequential order that they are decoded from the program. In a base form of the present system save, copy and load instructions can be executed in the sequential order that they are pushed into the execution buffer. Thus any load, copy or save lower in the execution buffer will prevent the execution of a load, copy or save higher up. In the preferred embodiment the operation of the system is optimized and may utilize forwarding reservations and/or copy and forward reservations.

A load instruction may be executed when:
1. there is a maximum of 1 save instruction lower in the execution buffer (excluding saves known to refer to different registers than the load being considered); and
2. there are no load instructions lower in the execution buffer (excluding loads known to refer to different registers than the load being considered); and
3. there are no copy instructions lower in the execution buffer (excluding copy instructions known to refer to different registers than the load being considered). Note however, this condition can be removed by extending the functionality associated with the execution of copy instructions to deal with the situation where the register contains a forward reservation; in this case the copy can be implemented to ensure the overall functionality is still satisfied.

If a load instruction is executed and references a register that is empty, then a reservation will be placed in the execution buffer to replace the load instruction and a forwarding reservation will be placed in the register such that it will forward data to the reservation in the execution buffer.

If a load is executed and references a register which already has data in it, then the data will replace the load instruction in the execution buffer and the register will be emptied.

If a load is executed and references a register which already contains a copy and forward reservation, then the load instruction in the execution buffer will be replaced with the copy and forward reservation and a forwarding reservation will be placed in the register such that it will forward data to the said copy and forward reservation in the execution buffer.

A copy instruction may be executed when:
1. there is a maximum of 1 save instruction lower in the execution buffer (excluding saves known to refer to different registers than the copy being considered); and
2. there are no load instructions lower in the execution buffer (excluding loads known to refer to different registers than the copy being considered).

If a copy instruction is executed and references a register that is empty, then a reservation will be placed in the execution buffer to replace the copy instruction and a copy and forwarding reservation will be placed in the register such that it will forward data to the reservation in the execution buffer.

If a copy is executed and references a register which already has data in it, then a copy of the data will replace the copy instruction in the execution buffer and the register will remain unchanged.

If a copy is executed and references a register which already contains a copy and forward reservation, then the copy instruction in the execution buffer will be replaced with the copy and forward reservation previously in the register and a copy and forwarding reservation will be placed in the register such that it will forward data to the correct location in the execution buffer.

A save instruction may be executed when:
1. there are no save instructions lower in the execution buffer (excluding saves known to refer to different registers than the save being considered); and
2. there are no load instructions lower in the execution buffer (excluding loads known to refer to different registers than the save being considered).

If a save can execute, then the data operand will be stored in the specified register. However, following the description above, if that register contains a reservation then writing data onto it will result in further functionality (for example a forwarding reservation will forward the data onto another location). The system can be further optimized such that as and when the save is executed it simultaneously checks the contents of the specified register and if that register contains a reservation the system performs the composite functionality in one step rather then as a series of steps.

The system is able to detect a number of error conditions and as described herein can generate error and exceptions as appropriate. For example, if a save tries to execute but the specified register already contains data or a task endeavors to terminate and a register contains a reservation then these conditions can be individually detected and error or exception conditions generated as appropriate for an implementation. It is a significant feature of the present system that the hardware can detect a number of different error conditions within the execution of a task. Some prior art system may detect error conditions associated with the execution of a single instruction, for example a divide by zero. However, such prior art system simply set error flags that the program can then interrogate. However, in the present system the hardware can suspend a task and can create a new task that may deal with the error condition and which may access the Execution State of the errored task.

In addition, it is also a significant feature of the present system that the hardware circuitry can detect various error conditions associated with program execution and data flow, including but not limited to: (1) a subroutine or function attempting to return the wrong number of results, (2) an instruction not having the correct number of operands, (3) an instruction operating on data which is of the wrong type (for example, a programming error resulting in an integer operation being executed with operands that actually contain non integer data) and (4) a programming error resulting in the invalid overwriting of data.

The instruction decoder associated with an Execution Unit can also be optimized in the preferred embodiment. Where a load, copy or save instruction is preceded by an instruction that will put an immediate data value onto the execution buffer (which will then become the index operand for the load, copy or save), then the instruction decoder may combine these before adding them to the execution buffer and will push a LoadI, CopyI or SaveI instruction onto the execution buffer (that is a load, copy or save with the register index embedded within it).

Further to general purpose registers, the preferred embodiment will also have a dedicated register that is primarily used to move data from one part of the program sequence to another. This will act as a side register whereby a Push instruction will take a data item from the execution buffer and place it into such a register (without the Push instruction having an operand to specify the register index or address). Later within the program, a Pull instruction can be used that will move the pushed data back into the execution buffer. Similarly to register instructions, the push/pull instructions will need to ensure that they only execute in the correct order. A Pull instruction may operate:
1. when there are no other Pull instructions lower in the Execution Buffer; and
2. the Push/Pull register contains valid data.

The execution of this instruction will simply move the contents of the Push/Pull register to the execution buffer, replacing the Pull instruction, and then the Push/Pull register is empty.

A Push instruction may operate:
1. When there are no other Push instructions lower in the Execution Buffer; and
2. the Push/Pull register is empty.

The Push instruction will require a single operand. When executed, the operand will be stored into the Push/Pull register and the instruction and operand can be removed from the execution stack.

The Push/Pull instructions can be considered as SaveI and LoadI instructions respectively, with the register index being implicit gained from the Push/Pull instruction. The encoded register index within the instruction may point to the specific Push/Pull register rather than a general purpose register. It may also be possible for the instruction decoder to decode Push and Pull instructions from the program code such that they are pushed into the instruction buffer as SaveI and LoadI type instructions.

Push and Pull instructions may also be implemented without use of an intervening register and/or without such a register in the Execution State for the task. In such circumstances the Push instruction will be executed once the Pull instruction is also in the execution buffer (thereby placing a limit on how far apart within the program these instruction can be) and the Push instruction will immediately move its operand to satisfy the Pull, with both instructions being removed from the execution buffer.

In addition, the present system may be enhanced further such that if an intervening register is used, then the Pull instruction can be executed prior to the Push executing by means of the Pull placing a reservation in the execution buffer (for the result of the Pull) and placing a forwarding reservation in the intervening Push/Pull register such that it references the reservation in the execution buffer.

In a further enhancement of the present system the Pull instruction may wait in the execution buffer, but if present in the execution buffer when the Push instruction executes then the corresponding data item will immediately satisfy the Pull instruction (in the execution buffer) rather than first being stored in the Push/Pull register.

It is possible to further enhance the present system to use a plurality of Push/Pull registers such that multiple Push and Pull instruction pairs can be interleaved. This could be achieved, for example, by means of the instruction decoder converting the first Push to a SaveI with an index of the first Push/Pull register and converting the first Pull to a corresponding LoadI and then converting the next Push to a SaveI with an index of the second Push/Pull register and so forth. When the instruction decoder has used the last Push/Pull register is can begin the process again using the first.

It is further proposed that an instruction may be implemented that will take two or more operands and return them back in a different order. This instruction is referred to herein as a Shuffle instruction. Shuffle instructions allow programs to adjust the order in which data values are present within the execution buffer. The data items may be results of executed tasks and may be in the wrong order for further execution. At least one shuffle instruction can take two operands and return them in reverse order. For example, the stack may contain #12, #3, Shuffle, Divide. The Shuffle will execute and return the operands in the reverse order thus the buffer will look like #3, #12, Divide. The Divide instruction may divide the 12 by the 3 and therefore result in 4. It may be possible for a Shuffle instruction that takes three operands. This instruction may return the operands in a rotated sequence. For example C, B, A, Shuffle may return B, A, C after the Shuffle executes. Depending on implementation this instruction could alternatively return A, C, B onto the buffer.

An implementation may also include an instruction that duplicates a data item in the execution buffer. A simple Duplicate instruction may take a single data operand return two results, which are both copies of the operand unchanged. This may be useful where a result from a previous instruction is required for two or more further instructions as operands.

Similarly, a Remove instruction may remove a data item from the execution buffer. A Remove instruction may be implemented to remove a single data item from the buffer. The Remove instruction will take a single operand and return no results, thus removing the instruction and operand.

FIG. 10 illustrates an implementation of the instruction decoder (402). An Execution Unit (401) provides the program counter on connection PC to the instruction decoder. The PC connection may also indicate if the PC value is valid; for example by means of a control signal. Buffer controller 509 controls a program buffer 505 such that the buffer is loaded with program information for a continuous section of the program including but not necessarily limited to the program information located at the address specified by PC. Within the preferred embodiment unit 506 is a register use by buffer controller 509 to record the amount of valid program information contained in program buffer 505 and unit 507 is a register that is used to indicate the start address of the program data in program buffer 505; which may be different to PC. Buffer controller 509 will request reads of memory sufficient to ensure that program information for PC is in buffer 505 and/or to ensure that program buffer 505 contains as much program information as possible. These read requests are issued on connection R. Fetched memory is received on connection A and placed into the buffer 505.

Unit 508 is a decode unit which uses the valid data in program buffer 505 to decode the instruction/data located at the address specified by PC. The data or instruction so decoded is sent to the Execution Unit by connection I. Any flags or tag information associated with the decoded instruction/data is communicated on connection F. For example, if decoder 508 decodes an instruction the tag information provided on F will be an instruction tag, whereas if decoder 508 decodes a Load instruction to load an immediate integer value it may decode that integer value (which is passes on connection I) and the tag information will then be a data or integer tag. The information provided on connection I and/or F may also contain information sufficient for the Execution Unit to update the PC accordingly to be the address of the next instruction/data (that is such information would indicate the amount of memory used by the instruction/data currently being provided on connection I).

In FIG. 9, the instruction decoder (402) has been connected to a memory interface 407. The memory manager will accept fetch and write requests from hardware units and facilitate in the control of fetching and writing of data from and to memory (406). Memory interface 406 may enable memory to be shared between multiple Execution Units and may thus have connections to multiple instruction decoders 402.

Circuitry can be implemented to enable the processing of a task. In the preferred embodiment an Execution Unit 401 contains the circuitry for this.

FIG. 7 shows the instruction flow structure for the basic execution mechanism. Instruction Decoder 402 will decode instructions obtained from memory and will provide decoded items (instructions and/or data) to Execution Unit 401 which will push the said items into the execution buffer which is contained within unit 401.

In the preferred embodiment of the present system, Execution Unit 401 will output the value of a program counter to the instruction decoder 402. Execution Unit 401 may also output a control signal indicating the validity of the program counter value. The program counter value will be sufficient to identify or derive the location of the next program item (for example, instruction or data) required by the Execution Unit 401. Instruction decoder 402 will read the program memory and obtain the required program information. It will decode the program items (such as instructions or data) and provide these to unit 401. As described herein, instructions may be encoded in such a way that different instructions require different amounts of memory to encode them. So instruction decoder 402 may provide unit 401 with a signal indicating the size used to encode the instruction currently being provided and unit 401 increments its program counter in dependence of this value. Instruction decoder 402 may be implemented such that it can potentially decode and output a plurality of instructions and/or data values simultaneously to the unit 401 connected to said instruction decoder 402.

Importantly, in the preferred embodiment it is proposed that the functionality of some or all instructions are dependent upon both the instruction and the operands. Thus an “Add” instruction will have different functionality when used with two integers compared to when used with two floating point numbers.

When instructions are ready for execution (that is the correct number of operands are available for an instruction and all are valid), Execution Unit 401 will issue the instructions to one or more functional unit 403, which are function units or Execution Unit 401 will otherwise execute the instruction (for example internally within the unit 401). The 403 function units can each support one or more types of instruction. In the preferred embodiment the operands communicated to functional unit 403 will also embody information to indicate the type of operand (for example, integer, byte, character, etc.); this may be a direct copy of the tag information used within the execution buffer or may have a different format and/or range of values. Thus each functional unit 403 can be implemented to execute specific combinations of instruction and operand types. Thus one functional unit 403 may support floating point arithmetic whereas another may support integer arithmetic. Both may support, for example, the Add instruction but neither may be able to execute any particular instance of the Add instruction (when considered with its operands) and they may each support the execution of different combinations of instruction and operand types.

It is a significant feature of the present system (when taken with other aspects of the system) that a processor may contain multiple function units 403 and that they may be shared between multiple Execution Units 401 and further that each functional unit 403 may simultaneously buffer instructions from different Execution Unit 401.

An implementation may contain one or more functional units 403. FIG. 8 illustrates an implementation of functional unit 403. The illustrated implementation has two inputs: A and B. Each of these inputs provides a complete instruction with operands and control signals (including sufficient information to correctly return the result(s) of the instruction). The implementation can therefore accept instructions from two Execution Units 401 (see FIG. 7) (one on the A connection and one on the B connection). Other implementations may have different numbers of connections and a functional unit 403 could be connected to a single Execution Unit 401. Also, where an implementation contains multiple units 403, some connections between one or more Execution Unit 401 and functional unit 403 may go to either all unit 403 or just a subset of them. Thus an Execution Unit 401 may have multiple connections each to any permutation of unit 403.

The control signals on the input connections to functional unit 403 will indicate the presence of a valid instruction on the connection and may indicate whether any other functional unit 403 (in a multi-unit 403 implementation) is taking the instruction, in which case the present functional unit 403 may ignore the instruction. The control signals may also indicate the priority of the associated instruction. In the preferred embodiment this priority is copied from the priority of the parent process, and the parent process (executing in an Execution Unit) will store this priority as part of its Execution State. Thus, the priority of a task is inherited by the task's children. Specific instructions can be designed to modify a task's priority but an implementation may limit the use of such instruction, for example such that tasks can only decrease their priority. Alternatively, since a task's priority is part of its Execution State, an implementation may allow general instructions, such as read and write, to be used and for these to modify a task's priority.

Unit 503 controls the receipt of instructions into functional unit 403. In the illustrated implementation unit 503 can control the simultaneous receipt of two instructions. Buffer 502 is a buffer within functional unit 403. This can store complete instructions with operands and associated information (such as operand type information and priority data). Buffer 502 can be implemented as a first-in first-out buffer or in the preferred embodiment would output the oldest highest priority instruction. Thus it will output an instruction according to priority, but where there is more than one instruction of a given priority, it will output the instruction that has been in the buffer the longest.

Unit 503 also controls a multiplexor 504. Unit 501 is the circuitry that will actually perform the supported instructions. It can be implemented in a variety of known ways and circuits exist to process an instruction with operands. It can optionally be implemented as a pipeline circuit (enabling multiple instructions to be simultaneously dealt with in a pipeline) and/or can have an additional buffer prior to the actual processing circuitry.

Unit 503 will control multiplexor 504 to output an instruction into unit 501. In the preferred embodiment unit 503 will control multiplexor 504 such that:
1. If functional unit 403 is simultaneously receiving multiple instructions (for example on both the A and B connections), then unit 503 will endeavour to store the lower priority instruction in buffer 502 while controlling multiplexor 504 to output the higher priority instruction to unit 501 (if both instructions are equal priority then unit 503 can perform the same functionality but output either instruction to multiplexor 504);
2. If unit 403 is receiving a single instruction (on connection A or B) then it can control multiplexor 504 to output the received instruction if either buffer 502 is empty or if the received instruction is of higher priority than the instruction presently being output by buffer 502; and
3. In other conditions multiplexor 504 will be set to connect the output of buffer 502 to unit 501.

If a system contains multiple functional unit 403 such that two or more units 403 can each support the execution of some set of instructions (possibly in additional to being able to execute some instructions that other unit 403 do not support), then it is possible to interconnect the units 403 such that if one unit 403 has one or more instructions buffered (for example in buffer 502) and another unit 403 has no instructions to execute then the buffer 502 in one unit 403 can transfer one or more instructions to the empty unit 403.

Functional Unit 403 may be implemented with more than one unit 501. In such an implementation it may be possible to input instructions to more than one unit 501 in any clock cycle. It may also be desirable to have multiple units 501 where each unit 501 may take multiple clock cycles to execute one instruction. Such a configuration of functional unit 403 could be implemented several ways including having a multiplexor 504 (or modified version thereof) for each unit 501 or having a single multiplexor 504 the output of which is connected to all unit 501 such that only one unit 501 can accept the current output of multiplexor 504 in any clock cycle.

FIG. 9 illustrates an implementation whereby a plurality of Execution Units 401 are connected to a plurality of functional unit 403. As explained herein, unit 403 may be implemented with multiple input connections. Thus a plurality of units 401 can be connected to one or more units 403 by means of one or more connections (buses). For example, some or all units 401 could be implemented with two output connections such that they can output an instruction (with operands and control signals) on either connection:
1. A unit 401 may be implemented such that it, can simultaneously output a plurality of instructions if it has more than one instruction ready for execution;
2. A unit 401 may be implemented such that it can output one instruction and can do so on one of several connections. It may be implemented such that other unit 401 are using some connections it can use a/the free connection to output its instruction; and
3. A plurality of units 401 can be connected such that they have predefined priority in terms of access to connections (thus the first Execution Unit 401 will have priority, the second will be allowed to output instructions if the first unit is not using a connection and so on) and/or such that shared control circuitry may arbitrate situations where multiple unit 401 wish to simultaneously output instructions. Such control circuitry may be provided with priority information for each instruction and may allow the highest priority instruction(s) access to the connection(s).

Note that some or all Execution Unit 401 may be implemented such that they can execute some instructions internally within the unit 401. In such situations the Execution Unit 401 may be implemented with the capability to execute one or more instructions internally while issuing one or more other instructions (for example to the functional unit(s) 403).

As stated, a unit 401 may have multiple connections to functional unit 403. In some implementations particular connections may only be able to accept a subset of instructions and may be optimized for those instructions. Thus, for example, some Boolean functions could be performed by a simple functional unit 403 connected directly to one or more units 401 and only able to accept specific instructions. For the avoidance of doubt, such optimized connections may be used for a subset of combinations of instructions and operand types. Thus in such implementations the use of such functional unit 403 and such connections is dependent upon both the instruction and the operand types.

When a functional unit 403 accepts an instruction it will indicate this to the issuing Execution Unit 401 via control signals within the connection. Where a system contains multiple functional unit 403, they can be organized in a variety of ways such that only one accepts a given instruction. For example, control signals may be daisy-chained between the functional units 403 to indicate to a particular unit whether a unit higher in the daisy-chain has/is accepting the instruction on a particular connection—in which case the relevant functional unit 403 will ignore the instruction.

Simple instructions may be executed within functional unit 403, for example integer arithmetic. However, unit 403 may not support all instructions—for example, an Execute instruction which executes a subroutine, function or program. Each Execution Unit 401 processes a task. An Execute instruction will generate such a task. Task controller 405 may receive an instruction (such as an Execute instruction) from a unit 401 in much the same way as a unit 403 does.

Task memory 404 is memory used to store a task's Execution State (or some portion of it). In the preferred embodiment of the present system a task's Execution State can be stored in a defined format in a block of memory. For example, an Execution State could be stored in 32 words of memory. This format may vary between implementations, between systems and/or within a system (between different units within the system). It is also explicitly recognized that the amount of information required to define a task may vary during the life of that task and thus the size of the Execution State may also be varied and the system may support one or more formats for storing or encoding an Execution State. A task memory 404 may also be shared between a number of processors (herein referred to as a cluster) such that it acts as a common store of tasks. Also, that task memory 404 can be divided into a number of blocks, each able to store data for one task. Each block can have a unique block number and an implementation can use this as part of the address used to access task memory 404 and/or the task and/or Execution State.

Within a cluster, a task can be identified by its block number in task memory 404. Thus the block number together with an offset can be used to identify a location within the Execution State and can, for example, be used as a return pointer to return results from a child to a parent task. When task controller 405 receives an instruction that requires a new task to be created, it can do so by allocating a currently unused block in task memory 404, the block number thereby being used as the task identifier. Task controller 405 then marks that block as used. This can be achieved by the task controller 405 having one or more flags for each block in task memory 404 such that the flags can indicate whether the block is allocated (is empty or is in use). The flags can additionally be used to indicate whether the task is currently stored in task memory 404 or assigned to an Execution Unit 401.

When a new task is created, the initial Execution State is also created and may, for example, be written to the relevant block of memory in task memory 404. However, if a unit 401 is able to immediate accept the new task then the task could be immediately issued to the unit 401 and the corresponding flags set to indicate this state.

An instruction that terminates an executing task is herein referred to as an End instruction (for the avoidance of doubt it is expressly recognized that the present system may have multiple forms of End implemented). The End instruction is supplied in a task at the point the task should conclude. It will indicate that the current Execution Unit should release the task and any other resources that may be associated with the executing task including that the identifier (assigned by task controller 405) can be released and marked as empty.

It is a significant feature of the present system (and has significance for the performance and operation of the system) that a task may return results at any stage during the execution of the task (not necessarily at the end of the task) and that a task may generate sub tasks but end before those sub tasks have themselves completed.

A task may not be released if there are still outstanding return results, i.e. there are still unsatisfied reservations within the execution buffer. Due to other tasks having a reference to a location to the current task for return results, the data will become invalid and thus cause the system to become unstable should the task be released before reservations are satisfied or references to them removed from the system. Further, it is desirable that all instructions that are already in the instruction buffer below the inserted End must also be completed before the End instruction is executed to terminate the current task. Once the task is released, the Execution Unit is empty and is available to start executing another task. The Execution Unit may be able to determine if there are still outstanding results from the current task to the parent task. It is an implementation decision as to what action to take in this situation. The Execution Unit may return the missing results with a special value, or may cause the task to enter an error condition.

The End instruction may not require any operand. It is possible for an Execution Unit to identify the End instruction as soon it is placed within the execution buffer (or as soon as it is decoded by the instruction decoder). In this situation the Execution Unit may stop accepting any more decoded instructions/data from the Instruction Decoder. This may simply be done by invalidating the PC signal to the said Instruction Decoder, and the operation of the End instruction may be just to change the task's Execution State including to remove or invalidate the program counter. In this modified state the task may continue to execute until such time as there are no instructions or reservations in the execution buffer and the task has no outstanding/unsatisfied results.

When an Execution Unit 401 is empty it can request a new task from task controller 405. It can do so by means of control signals connecting Executing Unit 401 and task controller 405. When task controller 405 receives a request from an Execution Unit 401 for a task it can facilitate the loading a task from task memory 404 to the Execution Unit 401 and can then mark that task as assigned (by means of the flags maintained in task controller 405). Further, task controller 405 can additionally use flags to indicate a form of status for tasks stored in task memory 404. This status can be used when determining which task to load to an Execution Unit 401. This status is explained herein using an example of a 2 bit status flag for each block in task memory 404, although implementations may vary. In the example the 2 bit status can have four values. For an unassigned task, the higher the value the more likely the associated task is to have instructions that are able to execute and therefore task controller 405 will prioritize the assignment of such tasks to Execution Unit 401.

It is expressly proposed that any unit within the processor may be idle, and this capability is a significant feature of the present system. For example, an Execution Unit that is empty and there is no task awaiting execution. It is also possible for an entire processor to be idle whereby all units are in a state of idle. The processor, or parts of, may still be used at such times as it is required to process a program or interrupt. In a multi-processor system, it may also be possible for multiple processors to be in a state of idle at any time. The entire system may be idle if, for example, there were no pending or executing tasks and there is no requirement in the system for a processor to continuously execute instructions. However, in an idle system an interrupt event (for example within the hardware) will generate a task that will then be executed.

In the preferred embodiment of the system any unit may also have a low power state which can be initiated whenever it is not busy or is idle. Thus an Execution Unit could go into a low power state when it has no task to execute and despite requesting a task from task controller 405 has not received a new task. In such an example the Execution Unit could disable or slow the clock signal to much or all of its internal circuitry except the circuitry essential to recognize that a task has become available for execution in the said unit.

During system start-up a/the processor will be signalled to create and start executing a task. Such a task may, for example, be a bootstrap program which is used to configure the computer system. This can be achieved within an implementation by circuitry that ensures an orderly initialization of the system generating an Execute command with an operand specifying the address or location of the bootstrap program. The said Execute instruction may be issued, for example to task controller 405, thereby creating a task within the system that will execute the required program. It may also be possible for multiple tasks to be created as a result of system start-up.

When a new task is created, it is likely to be able to execute immediately and its execution will not be immediately dependent on receiving further data (other than program data). Thus the status of a new task (stored in task controller 405) can reflect that the task is a priority for execution. In the example the status flag can therefore be set to 3 (the highest value). When task controller 405 receives a request to load a task from task memory 404 for execution in a unit 401 it can issue the task with the highest status value. Tasks may also have execution priorities set for or in the task. The task controller 405 may use this in combination with the status information to determine which pending task to issue to a unit 401. Execution Unit 401 may save the task that it is currently processing back into task memory 404. A connection can be provided between unit 401 and task memory 404 specifically for this purpose. A task can be saved to task memory 404 when it is not possible to immediately process the task further (for example, when the task is waiting for results from child tasks). In addition an implementation of the system can continually store changes to tasks (from unit 401 to task memory 404). Thus an Execution Unit 401 can detect when the connection to task memory 404 is otherwise idle, and when it is idle it can use the connection to save part of the current task's Execution State so as to maintain a copy of the task in task memory 404 which is as up-to-date as possible. For this purpose Execution Unit 401 can maintain a flag for each value that forms part of the Execution State to indicate that the value saved in task memory 404 is the same as the current value. Whenever an item in the task's Execution State in unit 401 changes (for example a new instruction is added into the execution buffer or an instruction executed), the associated flag is set and the flag is cleared if the item's value is copied to task memory 404. The flag is effectively a “dirty” flag and at any time it will indicate whether the associated data needing to be saved to task memory 404 before the unit 401 can release the task.

When an Execution Unit 401 saves a task back to task memory 404, it can release the task. It can do this by means of control signals with unit 405. Task controller 405 will set its flags for the task to indicate that the task is stored in task memory 404 and not assigned to a unit 401. In addition where a task is released by an Execution Unit 401, task controller 405 may set its status flags for the task to indicate that it is newly saved to task memory 404 and has a low priority for issuing it for further processing. In the example, the status for the task can be set to zero (the lowest value).

Unit 401 may also suspend a task, by saving it back to task memory 404, when there are outstanding sub-tasks that are expected to return results. Thus the task will have a number of reservations in its execution buffer. In the preferred embodiment, when a child task is issued by an Execution Unit 401 (from the task being processed by that unit) then a return pointer in the child (which will be used to return results to the reservation(s) in the parent) will be derived from the parent's task identifier and the said reservation's location within the parent. Optionally the child task may contain the parent's task identifier and an offset value for the reservation within the parent for the results of the child. The child task may also contain a value indicating the number of results which the parent is expecting.

There are a variety of ways for an implementation to deal with returning results from a child to a parent task as described earlier herein. When a Return instruction is ready for execution on a task's execution buffer, a return pointer for the result will be generated (“P”) and, for example, a Write(P, x) instruction could be issued where x is the result being returned. Alternatively other or dedicated instructions could be implemented within a particular system to achieve the same overall function. The pointer P will specify both the task and the location with the task's Execution State for the result to be stored at. This Write instruction could, for example, be communicated to the task controller 405 connected to the associated task memory 404 (which relates to the task identifier in P). The task controller 405 can then determine whether the task in question is stored in task memory 404, in which case it can perform the required function to execute the Write instruction thereby satisfying a reservation in the corresponding Execution State, or whether the task is allocated to an Execution Unit 401, in which case the unit 405 may issue the Write instruction to the said unit 401.

In the preferred embodiment the operation of the system is further optimized such that an Execution Unit 401, if it is executing a task, contains a record of the task's identifier (block ID in task memory 404). Then when a Write(P, x) instruction is issued where the pointer P is a reference to an Execution State, then some or all Execution Units 401 may be connected to the connection on which the Write instruction is issued. If an Execution Unit 401 detects that they are executing the task referenced by P (for example by comparison to P to the task identifier for their task) then they, in priority to task controller 405, may accept and perform the Write instruction thereby satisfying a reservation in their Execution State. If task controller 405 is physically separate to execution Unit 401 (for example, in separate silicon chips) then the processors, containing task controllers 401 and task memory 405 may be on a connection/bus that is used to communicate instructions including some or all of the Write(P, x) instructions used to return results between child and parent tasks. If any device detects such an instruction and that the referenced task is allocated to the device (for example to an Execution Unit 401 within the device) then that device may optionally accept and perform the Write instruction without the task controller 405 first processing it. Thus task controller 405 may only receive Write instructions for tasks stored in task memory 404 that are not executing in any Execution Unit 401.

If task controller 405 receives a Write(P, x) instruction (or other instruction that will modify an Execution State) it can determine whether the task specified in the pointer is assigned (to an Execution Unit 401) or is stored in task memory 404. If stored in task memory 404, then task controller 405 can store the x operand (the data to be returned to the parent task) in the appropriate location in task memory 404, also performing any checks (for example that the location references does contain a reservation) and updating any necessarily tag information for the location. Task controller 405 can also increment the status value for the stored parent task, thereby increasing the parent task's priority for processing. If the parent task is allocated to an Execution Unit 401, then task controller 405 can issue the return pointer and operand to the Execution Unit 401, which can then store the x operand appropriately in the reserved location. In both circumstances circuitry can verify that the location referenced by the return pointer is reserved. If not, this may indicate an error condition. An error will also exist if the return pointer references an unused task identifier (i.e. the block in task memory 404 was empty).

It is a significant feature of the present system that it further provides an optional system for the hardware to deal with events, which in a prior art system would result in an interrupt to the standard prior art processor.

Rather than have an interrupt structure, with interrupt signals to the processor, hardware may directly generate tasks within the present system. Such hardware can create and issue new tasks in a manner similar to an Execution Unit 401 creating a child task. Conveniently hardware can be connected to a task controller 405 and it is further proposed that the hardware could use a similar connection to task controller 405 as an Execution Unit 401 uses to create new tasks. A further form of implementation would be a connection (bus) that can communicate messages around the system including instructions (with operands and associated information). Such a connection could be used for Write instruction. It could also be used by hardware to generate an instruction that will generate a new task (or is effectively itself a new task). Task controller 405 may be connected to this connection and may receive and processor some or all instructions.

The following example illustrates hardware generating a task for a key being pressed on a keyboard.

Standard circuits exist to provide an interface to a keyboard such that circuitry can detect and decode key presses. Such a circuit can be connected to the present system. Once the key press has been decoded, circuitry can be used to connect to the task controller 405 to issue the new task to the unit 405 (for example, as described above). The new task will be dealt with in a similar manner to other tasks within the system. In more detail:
1. The task can specify the location, address or other identifier for the program that will process the task (the Program Pointer). If the hardware generating the event is connected by an instruction connection as described above then an Execute instruction could be conveniently issued by the hardware on the connection such that the instruction specifies the program to execute, a number of operands (for example the value of the key pressed) and optionally a return pointer. Additionally
2. the Program Pointer can be configured in the system during initialization, for example by means of the initialization software writing the Program Pointer's value to the keyboard interface or circuitry, and additionally
3. the task may contain the value representing the pressed key, and additionally
4. the created task can be constructed to return at least one result and the return pointer. When the task generates a result it will issue a Write(R, x) instruction where R is the return pointer. The said hardware may receive this instruction, determine that R references that hardware (or optionally a register, circuit or location in the hardware), and process the write instruction. This may complete the interrupt event for the hardware, for example enabling it to generate further interrupt tasks. Note that tasks can generate multiple results and this also applies to interrupt tasks and thus the hardware can be designed to receive multiple results from the interrupt handling software, potentially at different stages of execution of the interrupt event Additionally
5. the format of the return pointer used to reference the hardware can be an extension of an existing format (for example the hardware could be memory mapped or task memory 404 can be considered as part of the system hardware and therefore one format used to reference task memory 404 memory and other hardware) or a dedicated format.

The present system provides means to deal with a variety of error conditions within the system. Task controller 405 may be further enhanced to provide an error flag for tasks. For the avoidance of doubt it should be noted that the flags referred to for tasks can actually be stored in task memory 404 and can be stored with, in, or alongside the task in task memory 404. Each memory word may have a multi-bit tag associated with it to indicate the state of the word and this tag can have values indicating but not limited to empty, data or instruction. It should also be noted that, for the avoidance of doubt, the tags for different memory locations may vary in its size, format and values. Thus, for memory in task memory 404, which is used to store task data, the tag may have a value representing instruction information whereas in main memory such a value may (or may not) be supported, depending upon implementation. Within task memory 404 a block of memory is used for a task and the current state of the task can be stored in that memory block. Part of this memory block may be used to store status information and flags for the task.

In the preferred embodiment, task controller 405 also stores additional flag information separate to the task blocks (but can still use a specific part of the task memory 404 memory for task controller 405 operation—for example a particular range of addresses can be used as part of unit 405 functionality and another range of addresses used for task blocks).

If task controller 405 implements support for an error flag for a task, then it will not issue that task to a unit 401 for further processing. However, a means can be provided to enable a program to access memory in task memory 404 and/or status flags used by task controller 405. This can be achieved, for example, by means of a pointer format that references task memory 404 rather than other memory within the system.

If an error is detected with a task, then the task can be put into an error state (by saving the task to task memory 404, de-assigning it from any Execution Unit 401 and setting its error flag). A new task can then be created with a pointer to the said erroneous task, optionally a value indicating the type of error encountered and the location of the program that deals with such error conditions. This new task may be the equivalent of issuing the instruction Execute(Error_routine, Task_pointer, ErrorCode) where Error_routine is a pointer to the program to execute, Task_pointer is a pointer to the task in error and ErrorCode is the optional value. The Task_pointer may be similar to the return pointer used to return results from one task to another and may or may not contain an offset with the Execution State.

The present system additionally provides a means to modify some or all of the task flags used by task controller 405, including the error flag. The error state for a task may, in a particular implementation, be a specific value(s) or a multi-bit flag used to indicate task state, and states can include Suspended. Thus there may be a plurality of states. Some states may indicate that the task is assigned for processing, some states that it is saved to task memory 404 and unassigned, and other states that it is saved to task memory 404 and should not be assigned (such as suspended and error states).

In the present system the system can detect some program error conditions. For example, if an instruction exists in the execution buffer, then the system can determine whether there are sufficient data values, reservations and/or other instructions below that instruction to satisfy the instruction's operand set. If an instruction exists with insufficient operands (and there are no means for the operand set to be completed) then this can, within a particular implementation, be an error condition. Similarly an error condition can be generated if a task tried to terminate itself without having returned the correct number of results to the parent. However, in the latter situation the present system provides a further means to deal with this condition, whereby, if there are sufficient data items in the execution buffer to satisfy the outstanding results, then the system can push the same number of Return instructions onto the execution buffer as there are outstanding results. Alternatively the system can return special data values to the parent task which indicates a null result.

In summary, the present invention provides a computer processor comprising a memory and logic and control circuitry utilizing instructions and operands used thereby. The logic and control circuitry includes: an execution buffer each location of which can contain an instruction or data together with a tag indicating the status of the information in the location; means for executing the instructions in the buffer in dependence on the statuses of the current instruction and the operands in the buffer used by that instruction, and a program counter for fetching instructions sequentially from the memory. The tags include data, instruction, reserved, and empty tags. The processor may to execute instructions as parallel tasks subject to their data dependencies and a system may include several such processors. FIGS. 2-5 show successive stages of the execution buffer in performing a short program.

1. A computer processor for processing a computer program or part thereof including a number of instructions, where the overall function of the program is dependent on the instructions therein and at least in part on their order or position within the program, the processor including:
means to read and decode instructions within the program;
validity setting means for setting the validity of a data operand for an instruction; and
execution means for executing one or more instructions or tasks in dependence of the validity of the instruction's operands, the execution means being capable of executing instructions prior to completing the execution of one or more preceding instructions in the sequential order of the program.

2. A processor according to claim 1 wherein control circuitry determines the validity of an operand using a tag identifier or field associated with the operand.

3. A processor according to claim 2 wherein the tag identifiers include tag values to represent data, instruction and empty.

4. A processor according to claim 2 wherein the tag identifiers include one or more tag values to represent reservations.

5. A processor according to claim 1 wherein the processor includes at least one Execution Unit including:
an Execution Buffer operative to store decoded instructions, and
logic and control circuitry to store decoded instructions into the Execution Buffer and determine the number of valid operands currently available to one or more instructions within the said Execution Buffer and the number of operands required by those instructions and control circuitry to detect when an instruction is capable of being executed in dependence of the number of operands it requires and the number of operands available for the said instruction.

6. A processor according to claim 5 wherein the Execution Buffer may contain both instructions and data values.

7. A processor according to claim 5 wherein the control circuitry is operative to remove one or more instructions and operands from locations in the Execution Buffer in dependence on the capability of those instructions to be executed based on those instructions being ready to execute, and to set control information to indicate that one or more of the Execution Buffer locations previously occupied by the removed instructions and operands are empty.

8. A processor according to claim 6 wherein logic and control circuitry will execute a task (an instruction) and return the result(s) back to the Execution Buffer.

9. A processor according to claim 8 wherein the control circuitry is operative to form one or more tasks by removing one or more instructions and operands from locations in the Execution Buffer in dependence on the capability of those instructions to be executed that is based on those instructions being ready to execute, to set control information to indicate that one or more locations in the Execution Buffer are reserved, to execute the tasks, and to return a result or results of the tasks to previously reserved locations in the Execution Buffer.

10. A processor according to claim 8 wherein a return pointer will be generated for a task such that the return pointer will reference one or more locations in the Execution Buffer where one or more of the task's result or results will be returned.

11. A processor according to claim 10 wherein in that circuitry that executes a task will return a result using or in dependence of the return pointer.

12. A processor according to claim 11 wherein the returning of a result from a task will not necessitate the termination or completion of the said task.

13. A processor according to claim 11 wherein a task may return a plurality of results and each result may be generated and/or returned individually with a return pointer that specifies a location for that result.

14. A processor according to claim 6 wherein the Execution Buffer is a cyclic buffer.

15. A processor according to claim 6 wherein the Execution Buffer is a stack like buffer where information can be added to the top of the buffer but where any of the buffer contents can be removed from the buffer and/or accessed.

16. A processor according to claim 6 wherein the logic and control circuitry is operative to move one or more of the contents of the Execution Buffer while preserving the ordering within the Execution Buffer of all non-empty items.

17. A processor according to claim 1, wherein in that some tasks are assigned an identifier that provides a means to reference that task.

18. A processor according to claim 17 wherein when one task creates a second task a return pointer is created in dependence of the first task's identifier and the said return pointer is used with the second task.

19. A processor according to claim 18 wherein a return pointer is generated in dependence of a task's identifier together with an index or address for a reserved location in the Execution Buffer that is being used to process that task.

20. A processor according to claim 1, further comprising means for the processor to stop the current execution of a task, to store the state of the said task, and for the processor to commence the execution of another task.

21. A processor according to claim 17, wherein the state of tasks can be stored to and loaded from memory.

22. A processor according to claim 17 wherein a data value being returned to a task using a return pointer derived from the task's identifier will be correctly returned to the task irrespective of whether the said task is being executed, whether execution of the task is currently suspended, and/or whether the task is stored in memory.

23. A processor according to claim 1, wherein the control circuitry is operative to generate a new task in response to a hardware event or condition.

24. A processor according to claim 23 wherein the new task results from an Execute instruction being generated in response to a hardware event or condition.

25. A processor according to claim 24 wherein the Execute instruction also includes at least one operand from which the location or address of a program can be derived.

26. A processor according to claim 5 wherein the control circuitry is operative to enable an instruction in the Execution Buffer which has not yet executed to prevent the execution of another later instruction in the Execution Buffer until the first instruction is executed.

27. A processor according to claim 6 wherein instructions are provided to move data from one location in the Execution Buffer or program sequence to another.

28. A processor according to claim 1 wherein the control circuitry is operative to detect an error condition associated with the execution of a task and cause the suspension of the said task.

29. A processor according to claim 28 wherein in that the control circuit in addition to suspending the task in error will create a new task such that the new task will execute an error handling program and shall include an operand that identifies the task in error and/or its suspended location.

30. A processor according to claim 1 wherein an Execution Unit includes one or more registers accessible by instructions.

31. A processor according to claim 1 wherein a forwarding reservation can be placed in an Execution Buffer location or register location such that the said reservation references another location within the system containing the processor and such that when control circuitry executes a write or store instruction on the location containing the said reservation the control circuit will modify the instruction to refer to the location referenced by the said reservation and will empty the location previously containing the said reservation.

32. A processor according to claim 1 wherein a copy and forwarding reservation can be placed in an Execution Buffer location or register location such that the said reservation references another location within the system containing the processor and such that when control circuitry executes a write or store instruction on the location containing the said reservation the control circuit will modify the instruction to refer to the location referenced by the said reservation and also store a copy of the instruction's data operand to the location previously containing the said reservation.

33. A processor according to claim 1 further comprising circuits providing one or more functional units connected to one or more Execution Units, said functional units each being operable to execute some set of instruction types.

34. A processor according to claim 33 wherein a functional unit's ability to execute an instruction is dependent on the type of operands included with the instruction.

35. A processor according to claim 1 wherein the functionality of one or more instructions supported by the processor is dependent on the instruction itself and on the type of the operands supplied and the operands for an instruction are generated separate to the instruction.

36. A processor according to claim 1 wherein one or more instructions do not define the location or source of the instruction's operand(s) and the operand(s) are generated from to prior execution or operation of the task which the said instruction is part of.

37. A processor according to claim 1 wherein a task may be at least partially processed by one functional unit which then passes processing of the task to one or more other functional units including execution units dependent on the operand types or values and/or dependent on additional data used within the processing of the said task.

38. A processor according to claim 1 wherein a task is assigned an execution priority that forms part of the task's state.

39. A processor according to claim 38 wherein when one task generates another task the second task is given the same execution priority as the first task.

40. A computer system including one or more computer processors, each computer processor being operative to process a computer program or part thereof including a number of instructions, where the overall function of the program is dependent on the instructions therein and at least in part on their order or position within the program, each computer processor including:
means to read and decode instructions within the program;
validity setting means for setting the validity of a data operand for an instruction; and
execution means for executing one or more instructions or tasks—in dependence of the validity of the instruction's operands, the execution means being capable of executing instructions prior to completing the execution of one or more preceding instructions in the sequential order of the program.

41. A computer system according to claim 40 wherein the system includes means to assign task identifiers to tasks, means to store tasks in memory when said tasks are not being executed and means for an Execution Unit to save a task to memory and means for an Execution Unit to load a task from memory to the said Execution Unit.

42. A computer system according to claim 41 wherein when an Execution Unit wishes to load a task into the said Execution Unit the system will provide the Execution Unit with a task in dependence on the priorities of the tasks within the system and the status of those tasks.
